(19) United States
(12) Patent Application Publication
(10) Pub. No.: US 2012/0259996 A1
(43) Pub. Date: Oct. 11, 2012

(54) RECEPTION APPARATUS, RECEPTION METHOD, AND PROGRAM

(75) Inventor: Wataru Kondo, Chiba (JP)

(73) Assignee: SONY CORPORATION, Tokyo (JP)

(21) Appl. No.: 13/429,791

(22) Filed: Mar. 26, 2012

(30) Foreign Application Priority Data
Apr. 6, 2011 (JP) 2011-084905

(51) Int. Cl. G06F 15/173

(52) U.S. Cl. 709/233

(57) ABSTRACT

A reception apparatus includes: a reception unit configured to receive, from an information processing apparatus configured to distribute content, file data of the content transmitted in a file unit; a buffer configured to store the received file data; a change unit configured to change a bit-rate of the file data to be received; and a buffer control unit configured to delete, when the bit-rate is changed from a first bit-rate to a second bit-rate higher than the first bit-rate, file data other than files at least including a file being reproduced and a file to be next reproduced, out of the file data stored in the buffer.

### BACKGROUND

The present technology relates to a reception apparatus, a reception method, and a program. In particular, the present technology relates to a reception apparatus, a reception method, and a program that are capable of rapidly changing a bit-rate.

In recent years, services of distributing content via a network such as the Internet in a streaming method have generally been performed.

For carrying out streaming reproduction, a bandwidth is varied depending on a network environment, and thus content reproduction corresponding to a network bandwidth is demanded and it is necessary to change a bit-rate of content to be distributed.

As a technique relating to changing a bit-rate, for example, Japanese Patent Application Laid-open No. 2007-235357 (hereinafter, referred to as Patent Document 1) is known. Patent Document 1 discloses relieving sound interruption and sound quality deterioration in changing a bit-rate by buffer control.

### SUMMARY

However, according to the techniques in the related art, it is not sufficient to optimize the buffer control in changing a bit-rate, and thus it takes a lot of time to change a bit-rate.

In view of those circumstances, there is a need for enabling a rapid change of bit-rates to be performed.

A reception apparatus according to an embodiment of the present technology includes a reception unit configured to receive, from an information processing apparatus configured to distribute content, file data of the content transmitted in a file unit, a buffer configured to store the received file data, a change unit configured to change a bit-rate of the file data to be received, and a buffer control unit configured to delete, when the bit-rate is changed from a first bit-rate to a second bit-rate higher than the first bit-rate, file data other than files at least including a file being reproduced and a file to be next reproduced, out of the file data stored in the buffer.

The buffer control unit is configured to delete, when the bit-rate is changed from the second bit-rate to the first bit-rate, file data being written in the buffer.

The file data includes a video-encoded signal and an audio-encoded signal that are multiplexed. The reception apparatus further includes a demultiplexer configured to separate the file data into the video-encoded signal and the audio-encoded signal. The buffer control unit is configured to provide the demultiplexer with two or more file data items read out from the buffer.

The reception apparatus further includes a measuring unit configured to measure a reception speed of the file data to be received. The change unit is configured to change, based on the measured reception speed, the bit-rate.

The reception apparatus may be an independent apparatus or internal blocks constituting a single apparatus.

A reception method or a program according to another embodiment of the present technology is a reception method or a program corresponding to the above-mentioned reception apparatus according to the embodiment of the present technology.

In the reception apparatus, the reception method, and the program according to the embodiments, from the information processing apparatus configured to distribute the content, the file data of the content transmitted in a file unit is received. The received file data is stored. The bit-rate of the file data to be received is changed. When the bit-rate is changed from the first bit-rate to the second bit-rate higher than the first bit-rate, the file data other than files at least including the file being reproduced and the file to be next reproduced, out of the file data stored in the buffer, is deleted.

According to embodiments of the present technology, it is possible to rapidly change a bit-rate.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a configuration example of a content distribution system;

FIG. 2 is a diagram for illustrating the details of TS files;

FIG. 3 is a diagram showing an example of adaptive control of a bit-rate;

FIG. 4 is a diagram showing a configuration example of a client terminal apparatus;

FIG. 5 is a flowchart for illustrating content reception processing;

FIG. 6 is a diagram for illustrating buffer control in changing from a low bit-rate to a high bit-rate;

FIG. 7 is a diagram for illustrating buffer control depending on the number of TS files;

FIG. 8 is a diagram for illustrating buffer control in changing from a high bit-rate to a low bit-rate;

FIG. 9 is a diagram for illustrating buffer control depending on the number of TS files;

FIG. 10 is a diagram for illustrating the flow of data to be stored in each buffer;

FIG. 11 is a diagram for illustrating the flow of data in the case where the maximum number of TS files is limited; and

FIG. 12 is a diagram showing a configuration example of a computer.

### DETAILED DESCRIPTION OF EMBODIMENTS

Hereinafter, an embodiment of the present technology will be described with reference to the drawings.

### (Configuration Example of Content Distribution System)

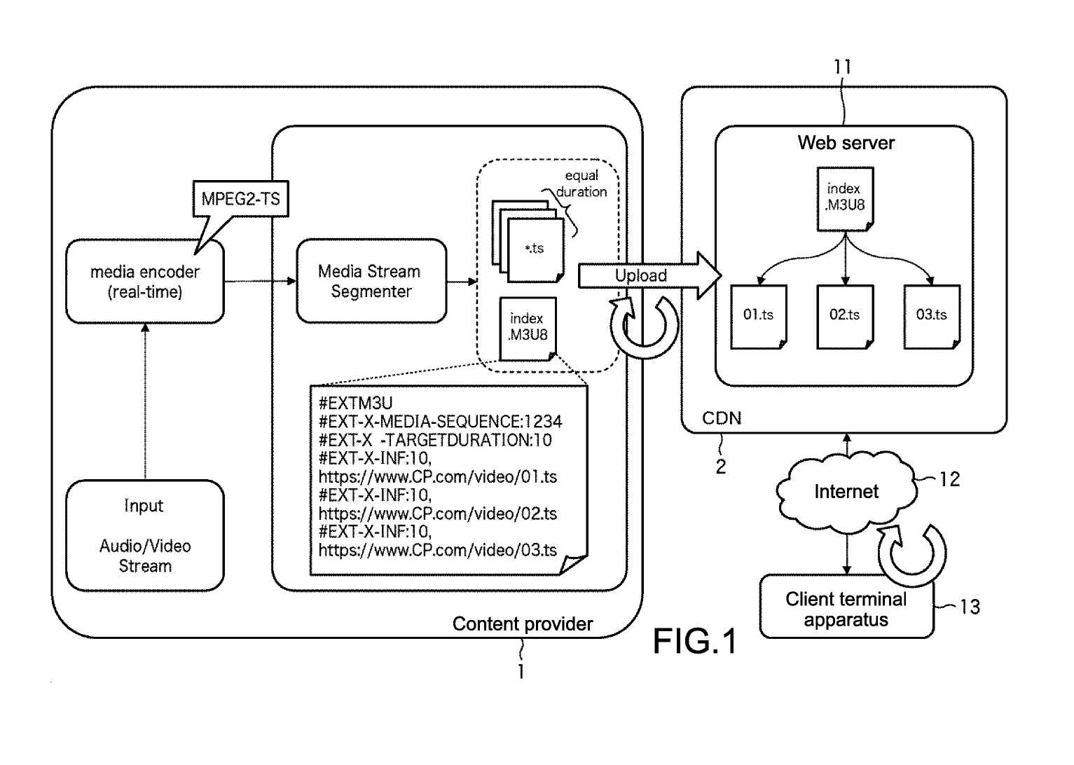

FIG. 1 is a diagram showing a configuration example of a content distribution system.

As shown in FIG. 1, in a content provider 1, a video stream and an audio stream of content to be input are encoded and multiplexed, so that a transport stream (TS) of an MPEG (Moving Picture Experts Group) 2 is generated.

The generated TS is segmented by a segmenter in a file unit, so that a plurality of TS files (*.ts) and an index file (index.M3U8) for managing these TS files are generated. The generated TS files and index file are uploaded to a web server 11.

The web server 11 is provided by a provider of a CDN (Content Delivery Network) 2. The web server 11 stores the TS files and index file uploaded by the content provider 1. In the example of FIG. 1, as the TS files constituting the single content, “01.ts,” “02.ts,” and “03.ts” are stored, and as the index file, “index.M3U8” is stored.

The web server 11 distributes (sends), according to a request from a client terminal apparatus 13, the TS files managed by the index file to the client terminal apparatus 13 via an Internet 12.

The client terminal apparatus 13 refers to an electronic apparatus connectable to the Internet 12, for example, a cellular phone or a personal computer. The client terminal apparatus 13 requests desired content from the web server 11, receives the TS files from the web server 11 via the Internet 12, and performs streaming reproduction.

It should be noted that although in the example of FIG. 1, for the sake of description, the single client terminal apparatus 13 is shown, a plurality of client terminal apparatuses are, in practice, connected to the Internet 12 so as to be accessible to the web server 11.

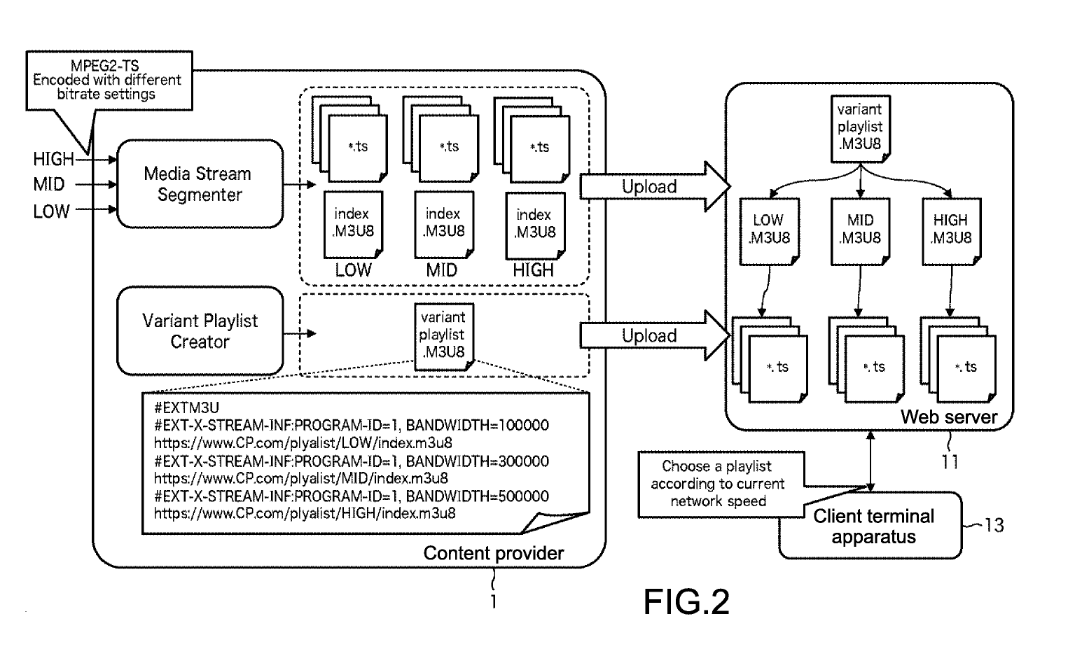

Next, referring to FIG. 2, the TS files uploaded to the web server 11 and distributed to the client terminal apparatus 13 will be described in detail.

As shown in FIG. 2, into the segmenter, TSs encoded at different bit-rates are input. For example, the different bit-rates include three types of bit-rates of a high bit-rate (HIGH), a middle bit-rate (MID), and a low bit-rate (LOW). In the stated order of the high bit-rate, the middle bit-rate, and the low bit-rate, the bit-rate is decreased.

In the segmenter, the TSs at different bit-rates are segmented in a file unit, and the TS files and the index files therefor are generated at a high bit-rate, a middle bit-rate, and a low bit-rate. Further, in a playlist creator, a playlist file for managing the index files is generated.

The TS files (*.ts) at a high bit-rate, a middle bit-rate, and a low bit-rate, the index file (index.M3U8) for each of the bit-rates, and the playlist file (variant playlist.M3U8) are uploaded to the web server 11.

Thus, in the web server 11, regarding the same content, three types of TS files of the content at different bit-rates are stored. Further, the index file for each of the TS files of the content and the playlist file for the index files are stored. The web server 11 manages the playlist file and distributes the three types of TS files of the content according to the request by the client terminal apparatus 13.

The client terminal apparatus 13 requests, based on the playlist file acquired from the web server 11, content at a desired bit-rate from the web server 11. The client terminal apparatus 13 receives TS files at the desired bit-rate from the web server 11 via the Internet 12 and performs streaming reproduction.

In this manner, in the content distribution system, content distribution depending on the desired bit-rate is performed, and thus the bit-rate of distributed content can be changed depending on the bandwidth of the Internet 12, for example.

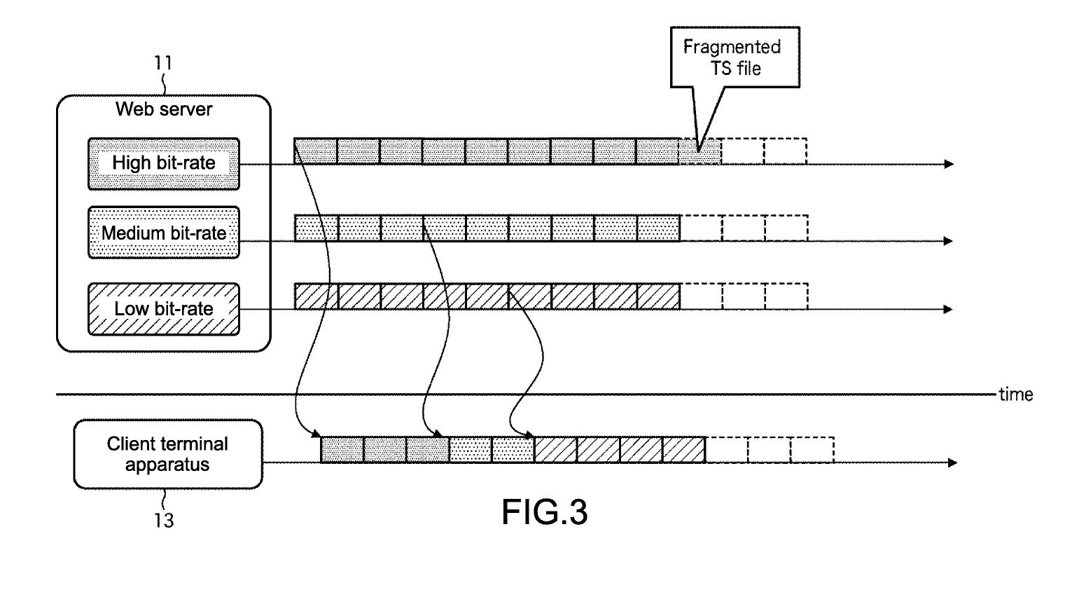

For example, as shown in FIG. 3, in the client terminal apparatus 13, when the streaming reproduction starts, the bandwidth of the Internet 12 is large, and thus streaming reproduction of the TS files at a high bit-rate is performed. At this point of time, in the client terminal apparatus 13, high-quality content is streaming-reproduced.

Regarding the first to third TS files, the TS files at a high bit-rate are received. However, after that, the bandwidth becomes narrower, and thus regarding the fourth and subsequent TS files, the TS files at a middle bit-rate are streaming-reproduced. At this point of time, in the client terminal apparatus 13, standard-quality content is streaming-reproduced.

Regarding the fourth and fifth TS files, the TS files at a middle bit-rate are received. However, after that, the bandwidth becomes further narrower, and thus regarding the sixth and subsequent TS files, the TS files at a low bit-rate are streaming-reproduced. At this point of time, in the client terminal apparatus 13, low-quality content is streaming-reproduced.

In this manner, in the content distribution system, the web server 11 can distributes, regarding the same content, a plurality of content files at different bit-rates, and thus in the client terminal apparatus 13, it is possible to adaptively control, depending on a network environment and the like, the bit-rate of the content.

The content distribution system is configured in the above-mentioned manner.

### (Configuration Example of Client Terminal Apparatus)

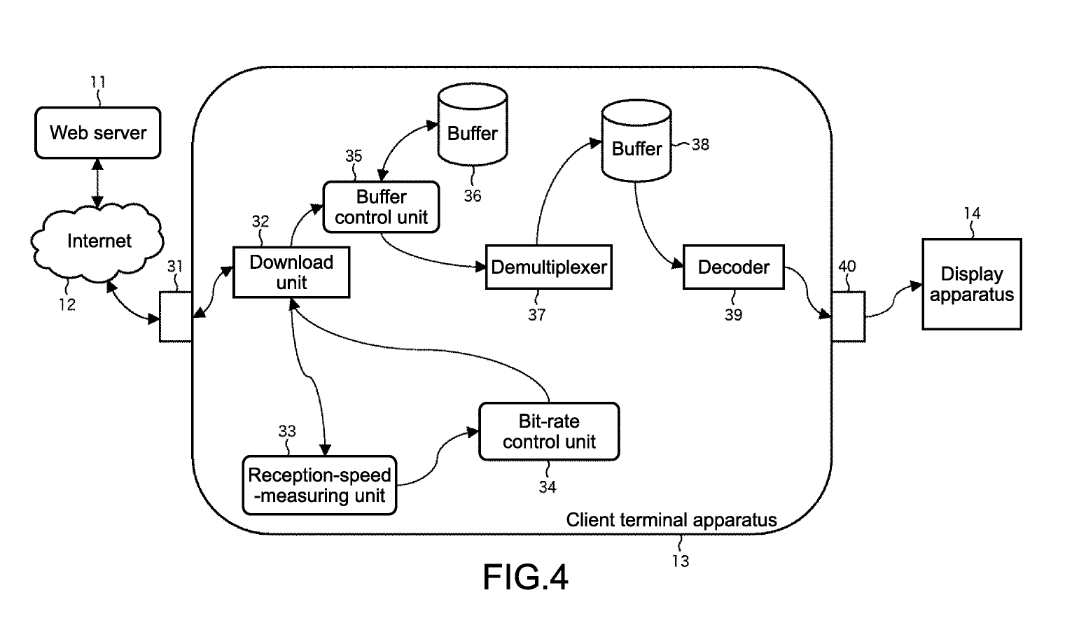

FIG. 4 is a diagram showing a configuration example of the client terminal apparatus.

The client terminal apparatus 13 includes a communication I/F 31, a download unit 32, a reception speed-measuring unit 33, a bit-rate control unit 34, a buffer control unit 35, a buffer 36, a demultiplexer 37, a buffer 38, a decoder 39, and an AV I/F 40.

The download unit 32 controls the communication I/F 31 to receive data of the TS files of the content from the web server 11 via the Internet 12. The download unit 32 provides the received data of the TS files to the buffer control unit 35.

The reception speed-measuring unit 33 measures a reception speed of the data of the TS files to be received by the download unit 32, and provides the result of the measurement to the bit-rate control unit 34.

The bit-rate control unit 34 chooses, based on the reception speed provided by the reception speed-measuring unit 33 or an instruction made by a user's operation, a bit-rate of the TS files to be received, out of the bit-rates described in the playlist file. The bit-rate control unit 34 instructs the download unit 32 to change to the chosen bit-rate.

The download unit 32 informs, according to the bit-rate-changing instruction by the bit-rate control unit 34, the web server 11 of the request to change the bit-rate of the TS files to be received via the Internet 12.

The buffer control unit 35 controls the buffer 36. The buffer 36 refers to an FIFO (First In First Out) buffer that temporarily stores the data according to the control by the buffer control unit 35.

The buffer control unit 35 writes, in the buffer 36, the data of the TS files from the download unit 32 and temporarily stores it. At the same time, the buffer control unit 35 reads out the data of the TS files temporarily stored in the buffer 36 and provides it to the demultiplexer 37.

The demultiplexer 37 separates the data of the TS files from the buffer control unit 35 into video-encoded signals and audio-encoded signals, and writes them in the buffer 38 and temporarily stores them.

The decoder 39 reads out the video-encoded signals and the audio-encoded signals temporarily stored in the buffer 38. The decoder 39 decodes the read-out video-encoded signals and provides the resulting video signals to a display apparatus 14 via the AV I/F 40. Further, the decoder 39 decodes the read-out audio-encoded signals and provides the resulting audio signals to the display apparatus 14 via the AV I/F 40.

The display apparatus 14 is connected to the AV I/F 40 and displays images corresponding to the video signals from the decoder 39. Further, the display apparatus 14 has a built-in speaker (not shown). The display apparatus 14 outputs audios corresponding to the audio signals through the speaker.

The client terminal apparatus 13 is configured in the above-mentioned manner.

### (Content Reception Processing)

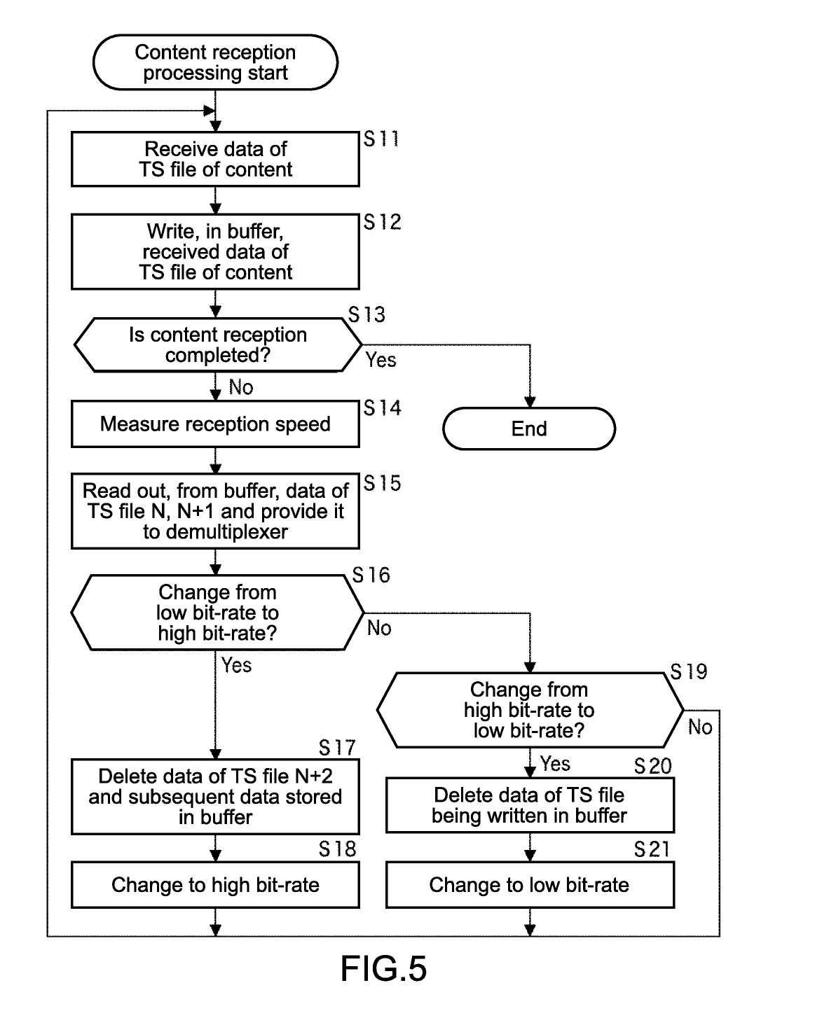

Next, referring to a flowchart of FIG. 5, content reception processing performed in the client terminal apparatus 13 will be described.

In Step S11, the download unit 32 receives the data of the TS files of the content from the web server 11. It should be noted that in the client terminal apparatus 13, for starting the content reception processing, a predetermined bit-rate is chosen by the bit-rate control unit 34 and the data of the TS files at this bit-rate is received.

In Step S12, the buffer control unit 35 writes, in the buffer 36, the data of the TS files received by the download unit 32.

In Step S13, the download unit 32 determines whether or not the content reception is completed. When it is determined that the content reception is completed (“Yes” in Step S13), the content reception processing in FIG. 5 is terminated.

In Step S13, when it is determined that the content reception is not completed, the processing proceeds to Step S14. In Step S14, the reception speed-measuring unit 33 measures the reception speed of the data of the TS files to be received by the download unit 32.

In Step S15, the buffer control unit 35 reads out a TS file N stored at the head of the buffer 36 and a TS file N+1 stored next to the TS file N, and provides them to the demultiplexer 37.

Thus, the TS file N and TS file N+1 written in the buffer 36 are read out and provided to the demultiplexer 37 by the buffer control unit 35 at a predetermined timing. Then, the demultiplexer 37 separates them into video-encoded signals and audio-encoded signals. The decoder 39 decodes the video-encoded signals and the audio-encoded signals into video signals and audio signals, respectively. The decoder 39 outputs the video signals and the audio signals to the display apparatus 14.

In Step S16, the bit-rate control unit 34 determines, based on the reception speed measured by the reception speed-measuring unit 33, whether or not the bit-rate of the TS files to be received should be changed from the low bit-rate to the high bit-rate.

In Step S16, when it is determined that the bit-rate should be changed from the low bit-rate to the high bit-rate, the processing proceeds to Step S17. Thus, for example, when due to variation of the bandwidth of the Internet 12, the reception speed increases, the bit-rate control unit 34 determines that the bit-rate of the TS files to be received from the web server 11 should be changed from the low bit-rate to the high bit-rate.

In Step S17, the buffer control unit 35 deletes, out of the data of the TS files that has been stored in the buffer 36, data of the TS files other than a TS file being reproduced and a TS file to be next reproduced. Thus, provided that the TS file being reproduced is the TS file N, data of a TS file N+2 and the subsequent TS files other than the TS file N and the TS file N+1 is deleted.

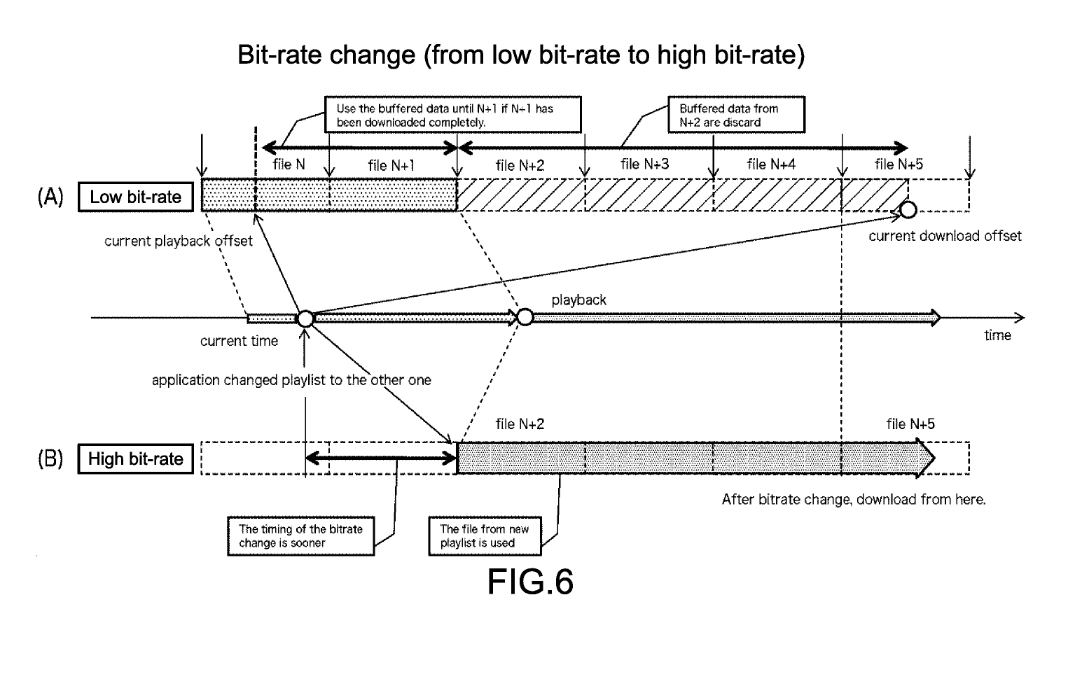

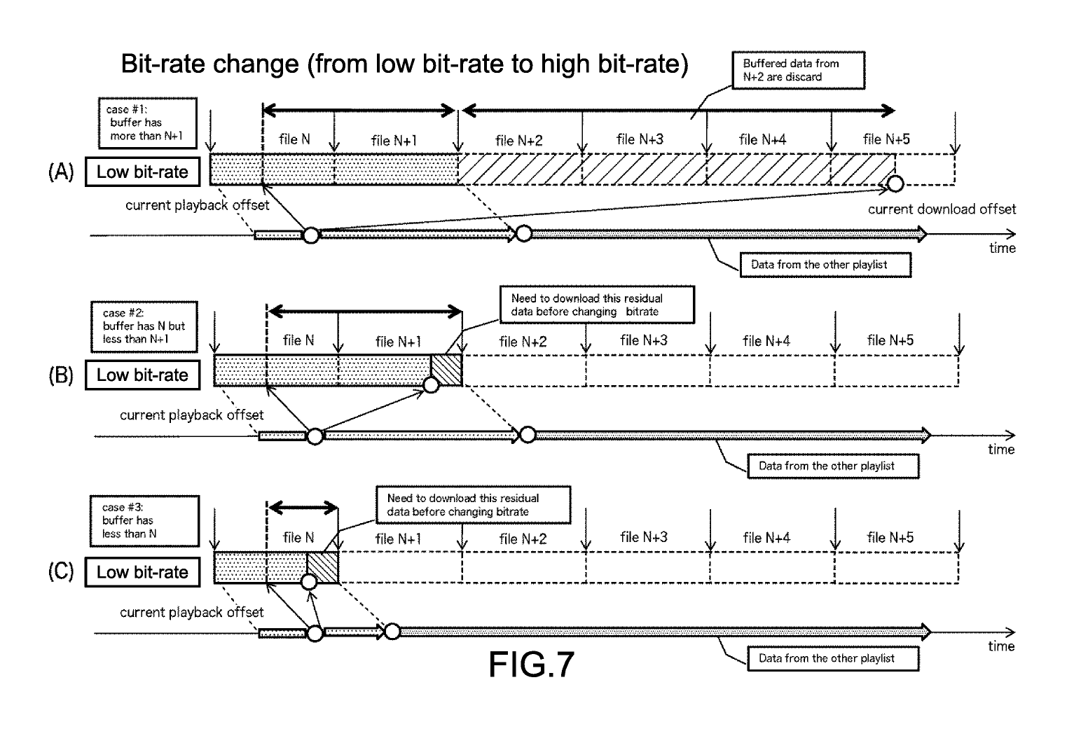

It should be noted that buffer control in the case of changing from the low bit-rate to the high bit-rate will be described later in detail with reference to FIGS. 6 and 7.

When the deletion of the data of the TS files is completed, the processing proceeds to Step S18. The bit-rate control unit 34 instructs the download unit 32 to change to the high bit-rate. The download unit 32 informs the web server 11 of the request to change to the high bit-rate via the Internet 12. In this manner, the bit-rate of the content to be sent from the web server 11 is changed from the low bit-rate to the high bit-rate.

Then, the data of the TS files at a high bit-rate is newly written in the buffer 36. However, the data of the TS file N+2 and the subsequent TS files at a low bit-rate has been deleted, and thus immediately after reproducing the TS file N and the TS file N+1, the reception of the TS files at a high bit-rate is started.

Therefore, if the data of the TS file N+2 and the subsequent TS files is not deleted, the data of the TS files at a low bit-rate is accumulated in the buffer 36, and thus it takes a lot of time to change to the data of the TS files at a high bit-rate. Further, as the volume of the buffer 36 becomes larger, more extra TS files at a low bit-rate are stored, and thus it takes a lot of time to change to the data of the TS files at a high bit-rate. However, by deleting the data of the TS file N+2 and the subsequent TS files at a low bit-rate, it is possible to rapidly change from the low bit-rate to the high bit-rate, which allows the user to immediately view the high-quality content.

Further, by leaving not only the TS file N being reproduced, but also the TS file N+1 to be next reproduced without deletion, it is possible to gain time for accumulating the data of the TS files at a high bit-rate in the buffer 36. Thus, without so-called re-buffering, it is possible to smoothly change the bit-rate.

On the other hand, in Step S16, when it is determined that the bit-rate should not be changed from the low bit-rate to the high bit-rate, the processing proceeds to Step S19. In Step S19, the bit-rate control unit 34 determines, based on the reception speed measured by the reception speed-measuring unit 33, whether or not the bit-rate of the TS files to be received should be changed from the high bit-rate to the low bit-rate.

In Step S19, when it is determined that the bit-rate should be changed from the high bit-rate to the low bit-rate, the processing proceeds to Step S20. Thus, for example, when due to variation of the bandwidth of the Internet 12, the reception speed decreases, the bit-rate control unit 34 determines that the bit-rate of the TS files to be received from the web server 11 should be changed from the high bit-rate to the low bit-rate.

In Step S20, the buffer control unit 35 deletes data of a TS file being written in the buffer 36. Thus, provided that the TS file being written is a TS file N+5, only the data of the TS file N+5 is deleted, and the data of the TS files N to N+4 completely written other than the TS file N+5 is not deleted.

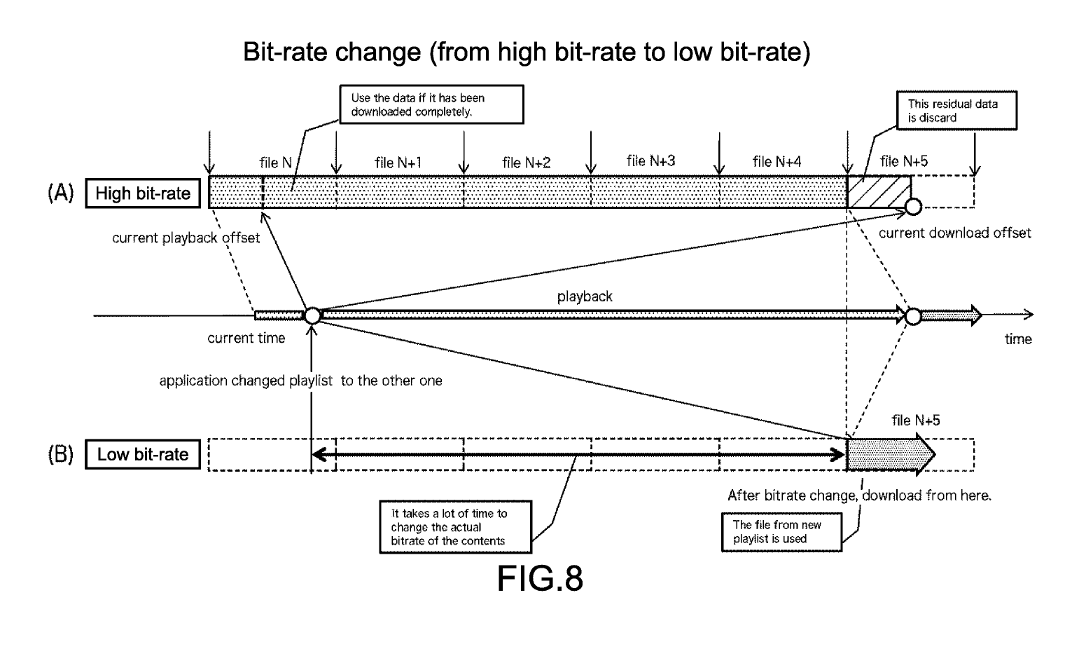

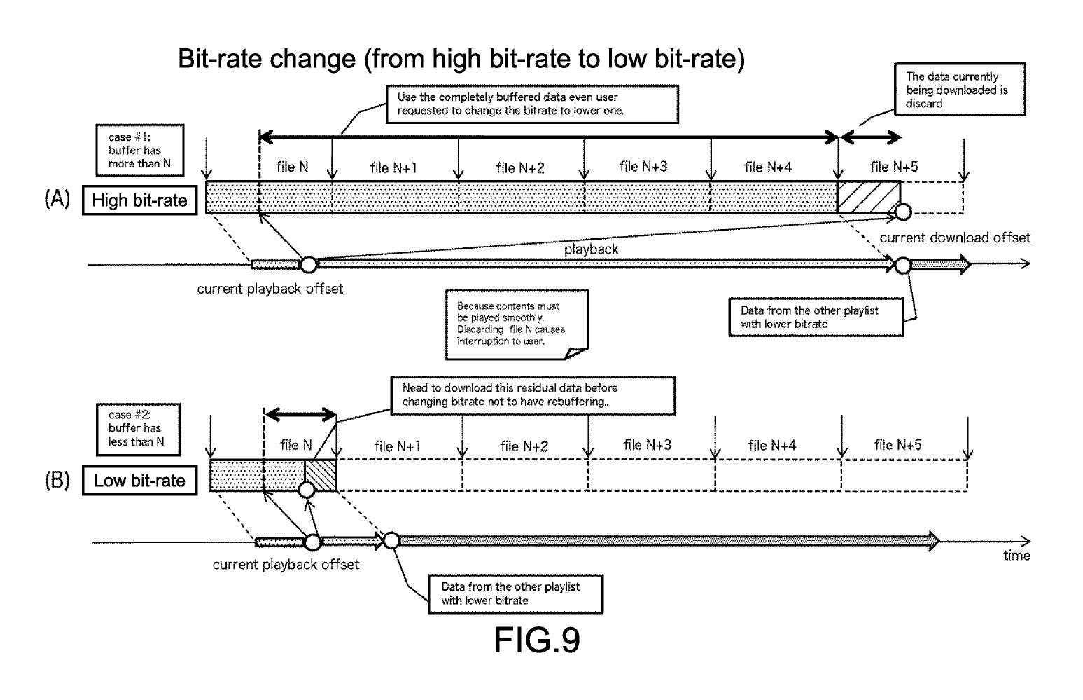

It should be noted that buffer control in the case of changing from the high bit-rate to the low bit-rate will be described in detail with reference to FIGS. 8 and 9.

When the deletion of the data of the TS files is completed, the processing proceeds to Step S21. The bit-rate control unit 34 instructs the download unit 32 to change to the low bit-rate. The download unit 32 informs the web server of the request to change to the low bit-rate via the Internet 12. In this manner, the bit-rate of the content to be sent from the web server 11 is changed from the high bit-rate to the low bit-rate.

Then, in the buffer 36, the data of the TS files at a low bit-rate is newly written. However, for example, only the data of the TS file N+5 at a high bit-rate is deleted, and thus before reproducing the TS files N to N+4, the reproduction of the TS files at a low bit-rate is not started.

That is, in the case of changing from the high bit-rate to the low bit-rate, by leaving the data of the TS files at a high bit-rate that has been already stored in the buffer 36 without deletion, it is possible to allow the user to view the high-quality content by an amount of the data of the TS files remaining in the buffer 36.

When either one of the processing in Steps S18 and S21 is terminated or it is determined that the bit-rate should not be changed from the high bit-rate to the low bit-rate (“No” in Step S19), the processing returns to Step S11 and the above-mentioned processing is repeated until the content reception is completed.

As described above, in the client terminal apparatus 13, in the case of changing from the low bit-rate to the high bit-rate, out of the data of the TS files at a low bit-rate that has been stored in the buffer 36, the data of the TS files other than the TS file being reproduced and the TS file to be next reproduced is deleted. With this configuration, it is possible to rapidly change the bit-rate.

Further, in the client terminal apparatus 13, in the case of changing from the high bit-rate to the low bit-rate, only the data of the TS file at a high bit-rate that is being written in the buffer 36 is deleted. With this configuration, it is possible to allow the user to view the high-quality content as much as possible.

(Buffer Control in Case of Changing from Low Bit-Rate to High Bit-Rate)

Next, referring to FIGS. 6 and 7, the buffer control in the case of changing from the low bit-rate to the high bit-rate will be described in detail.

In FIGS. 6 and 7, corresponding to the items of the high bit-rate or the low bit-rate, the data of the TS files that has been stored in the buffer 36 at respective bit-rates is shown. Further, it is assumed that a time direction is a direction from the left-hand side to the right-hand side in the figure.

As shown in the section (A) of FIG. 6, in the case of receiving the TS files at a low bit-rate, in the buffer 36, the data of the TS files at a low bit-rate is successively written and such data is read out in the order of writing.

For example, after the data of the TS files N to N+4 is successively written, in the case of changing from the low bit-rate to the high bit-rate when the data of the TS file N+5 is being written, the data of the TS files N+2 to N+5 is deleted. In this case, the TS file N being reproduced and the TS file N+1 to be next reproduced are not deleted.

After that, when the TS file N and the TS file N+1 at a low bit-rate are being reproduced, the reception of the data of the TS files at a high bit-rate is started. Then, as shown in the section (B) of FIG. 6, in the buffer 36, the data of the TS files at a high bit-rate is successively written from the TS file N+2. Immediately after the reception of the TS file N+1 at a low bit-rate is completed, the reproduction of the TS file N+2 at a high bit-rate is started, the TS file N+2 being a file continuous with the TS file N+1.

With this configuration, it is possible not only to rapidly change the bit-rate, but also to suppress the re-buffering because the data of the TS files N and N+1 at a low bit-rate is left. It should be noted that although extra data of the TS file N+1 is left for suppressing the re-buffering, extra data of the TS file N+1 and the subsequent TS files may be left. For example, only the data of the TS files N to N+2 at a low bit-rate needs to be prevented from being deleted. In other words, in the case of changing from the low bit-rate to the high bit-rate, out of the data of the TS files that has been stored in the buffer 36, the data of the TS files other than the TS files at least including the TS file being reproduced and the TS file to be next reproduced is deleted.

Further, the number of TS files to be stored in the buffer 36 is not constantly fixed, but changes depending on variation of the bandwidth of the Internet 12, processing ability of the client terminal apparatus 13, and the like. FIG. 7 shows an example of buffer control depending on the number of TS files that have been stored in the buffer 36.

As shown in the section (A) of FIG. 7, as in FIG. 6 above, in the case where N+1 or more TS files have been stored in the buffer 36, for example, the data of the TS files N+2 to N+5 is deleted and the data of the TS files N and N+1 is left. Then, in the buffer 36, the TS files at a high bit-rate are successively stored from the data of the TS file N+2.

Further, as shown in the section (B) of FIG. 7, in the case where the data of the TS file N and part of the data of the TS file N+1 have been stored in the buffer 36, after the data of the TS file N+1 is completely stored, the TS files at a high bit-rate are successively stored from the data of the TS file N+2. For example, when by a user's operation, the bit-rate is changed from the low bit-rate to the high bit-rate, such a case is assumed.

Further, as shown in the section (C) of FIG. 7, in the case where part of the data of the TS file N has been stored in the buffer 36, after the data of the TS file N is completely stored, the TS files at a high bit-rate are successively stored from the data of the TS file N+1. For example, so-called follow-up replay is applied to this case.

The buffer control in the case of changing from the low bit-rate to the high bit-rate is performed in the above-mentioned manner, so that depending on the network environment and the user's operation, the bit-rate of the content is adaptively controlled.

(Buffer Control in Case of Changing from High Bit-Rate to Low Bit-Rate)

Next, referring to FIGS. 8 and 9, buffer control in the case of changing from the high bit-rate to the low bit-rate will be described in detail.

In FIGS. 8 and 9, as in FIGS. 6 and 7 above, corresponding to the items of the high bit-rate or the low bit-rate, the data of the TS files that has been stored in the buffer 36 at respective bit-rates is shown.

As shown in the section (A) of FIG. 8, in the case of receiving the TS files at a high bit-rate, in the buffer 36, the data of the TS files at a high bit-rate is successively written, and such data is read out in the order of writing.

For example, the data of the TS files N to N+4 is successively written, and in the case of changing from the high bit-rate to the low bit-rate when the data of the TS file N+5 being written, only the data of the TS file N+5 being written is deleted. Therefore, in addition to the TS file N being reproduced, the TS files N+1 to N+4 are not deleted.

After that, when the TS files N to N+4 at a high bit-rate are being reproduced, the reception of the data of the TS files at a low bit-rate is started. Then, as shown in the section (B) of FIG. 8, in the buffer 36, the data of the TS files at a low bit-rate is successively written from the TS file N+5. Immediately after the reception of the TS file N+4 at a high bit-rate is completed, the reproduction of the TS file N+5 at a low bit-rate is started, the TS file N+5 being continuous with the TS file N+4.

With this configuration, it is possible to allow the user to view the high-quality content as much as possible, and to reduce a reception time of the low-quality content.

Further, as described above, the number of TS files to be stored in the buffer 36 is not constantly fixed, but changes. FIG. 9 shows an example of buffer control depending on the number of TS files that have been stored in the buffer 36.

As shown in the section (A) of FIG. 9, as in FIG. 8 above, in the case where N or more TS files have been stored in the buffer 36, for example, the data of the TS file N+5 being written is deleted and the data of the TS files N to N+4 is left. Then, in the buffer 36, the TS files at a low bit-rate are successively stored from the TS file N+5.

Further, as shown in the section (B) of FIG. 9, in the case where part of the data of the TS file N has been stored in the buffer 36, after the data of the TS file N is completely stored, the TS files at a low bit-rate are successively stored from the TS file N+1.

The buffer control in the case of changing from the high bit-rate to the low bit-rate is performed in the above-mentioned manner, and depending on the network environment and the user's operation, the bit-rate of the content is adaptively controlled.

### (Flow of Data in Each Buffer)

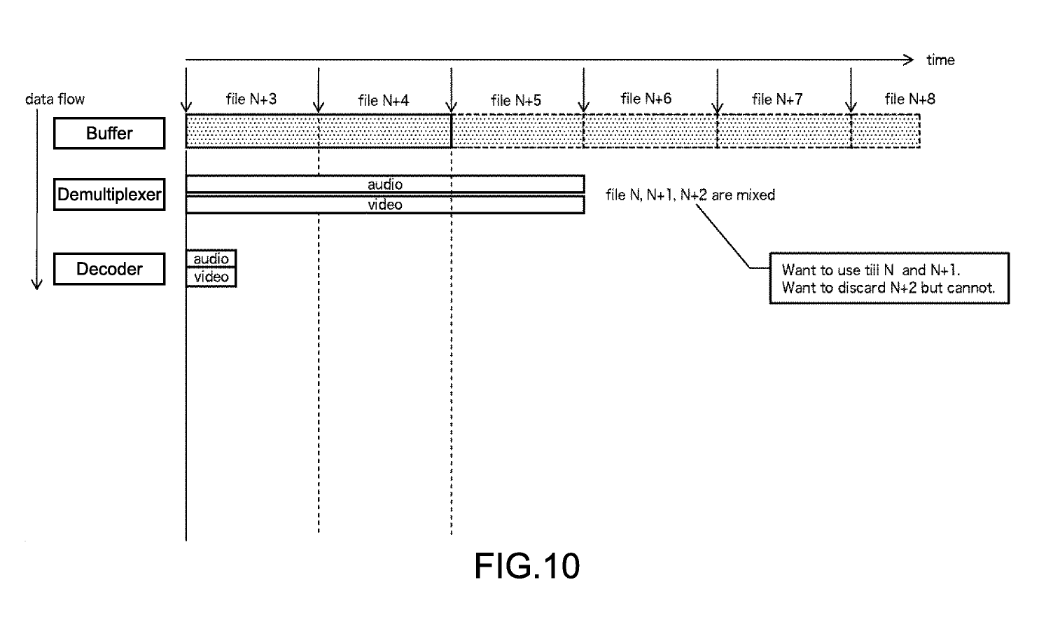

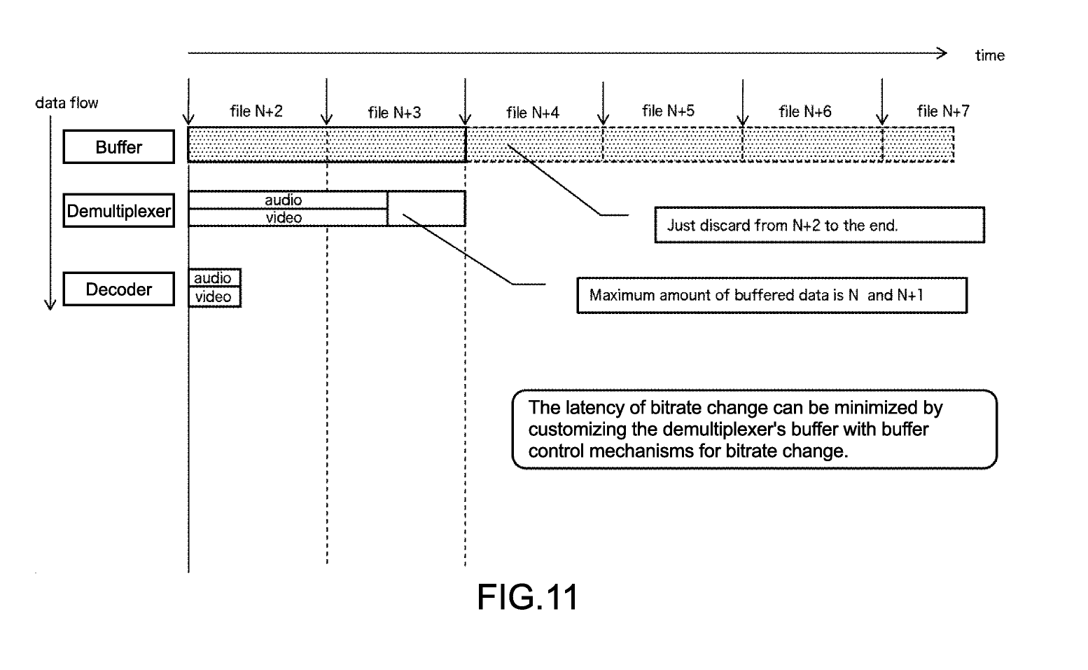

Next, referring to FIGS. 10 and 11, data to be stored in each buffer of the client terminal apparatus 13 will be described.

As mentioned above, the data of the TS files written by the buffer control unit 35 in the buffer 36 is successively read out and provided to the demultiplexer 37. The provided data is separated into video-encoded signals and audio-encoded signals. The separated video-encoded signals and audio-encoded signals are stored in the buffer 38. The video-encoded signals and audio-encoded signals that have been stored in the buffer 38 are successively read out and decoded by the decoder 39.

As shown in FIG. 10, in the case of reading out of the TS files successively written in the buffer 36 the data of the TS files N to N+2, when such data is separated by the demultiplexer 37 into video-encoded signals and audio-encoded signals, it is difficult to identify divisions of the TS files. Specifically, it is possible to identify divisions of the TS file N+3 and the subsequent TS files that have been stored in the buffer 36. However, in the case of the video-encoded signals and the audio-encoded signals that have been stored in the buffer 38, it is difficult to identify divisions of the TS files N to N+2.

In view of this, as shown in FIG. 11, by the buffer control unit 35, the maximum number of TS files to be provided to the demultiplexer 37 is limited to two. That is, it is difficult to identify the divisions of the TS files when these are separated into the video-encoded signals and the audio-encoded signals, and thus the buffer 36 is controlled at the previous stage so that the data of the TS file N and the TS file N+1 is provided to the demultiplexer 37 (processing of Step S15 in FIG. 5).

In other words, by limiting the maximum number of TS files to be provided to the demultiplexer 37, the TS files to be processed by the demultiplexer 37 and the decoder 39 are controlled.

With this configuration, in the buffer 36, for example, a division between the TS file N+1 and the TS file N+2 is identified, and thus based on this division, the data of the TS file N+2 and the subsequent TS files can be deleted.

Further, in the example of FIG. 10, for example, in the case where a buffer volume of the demultiplexer 37 is 5 Mbytes and the bit-rate of the content is 1 Mbps, TS files each having a file volume of 1 Mbyte are received. In the case where a processing time for each of the TS files is 8 seconds, in the demultiplexer 37, a processing time of 40 seconds (5*8 seconds) is necessary. Therefore, it takes 40 seconds to change from the low bit-rate to the high bit-rate.

On the other hand, as shown in FIG. 11, in the case of providing the data of the TS file N and the TS file N+1 to the demultiplexer 37 and deleting the data of the TS file N+2 and the subsequent TS files, in the demultiplexer 37, it takes 16 seconds (2*8 seconds) to process it. Therefore, it takes only 16 seconds at the maximum to change from the low bit-rate to the high bit-rate, and thus it is possible to rapidly change the bit-rate.

It should be noted that here, the purpose is to identify the divisions of the TS files, and thus the maximum number of TS files to be provided to the demultiplexer 37 is not limited to two, but it may be two or more. Further, by limiting the maximum number of TS files to be provided to the demultiplexer 37, the volume that the buffer 38 can use is limited, and thus it is desirable to increase the volume of the buffer 36, to thereby increase the data of the TS files to be stored in the buffer 36.

As described above, by optimizing the buffer control in changing the bit-rate, in the case of changing from the low bit-rate to the high bit-rate, it is possible to rapidly change the bit-rate.

In particular, in the case of performing streaming reproduction of live content, where review may be impossible, if it takes a lot of time to change the bit-rate, it may be impossible to view the high-quality content for the corresponding time period, which is disadvantageous for the user. Further, from the perspective of the content provider, an opportunity for distributing the content having a quality that satisfies the user is lost, which diminish the value of the provided services. However, in the present technology, by performing buffer control considering usability in changing the bit-rate, it is possible to rapidly change the bit-rate. Thus, it is possible to satisfy both of the user and the content provider.

Further, by optimizing the buffer control in changing the bit-rate, when the bit-rate is changed from the high bit-rate to the low bit-rate, it is possible to allow the user to view the high-quality content as much as possible, and to reduce a reproduction time of the low-quality content.

It should be noted that although in the above, changing the bit-rate between two types of bit-rates of the low bit-rate and the high bit-rate has been described, the relationship in speed between the bit-rates is relative, and, for example, regarding a middle bit-rate, the bit-rate can be similarly changed. For example, the middle bit-rate becomes a high-speed bit-rate in relation to the low bit-rate, while the middle bit-rate becomes a low-speed bit-rate in relation to the high bit-rate.

Further, although in the above description of the flowchart in FIG. 5, the changing of the bit-rate is automatically performed based on the reception speed measured by the reception speed-measuring unit 33, the bit-rate may be changed according to the user's operation.

(Explanation of Computer to which Present Technology is Applied)

A sequence of processing steps described above may be executed by hardware or software. In the case where of executing the sequence of processing steps by the software, a program configuring the software is installed into a general-purpose computer, for example.

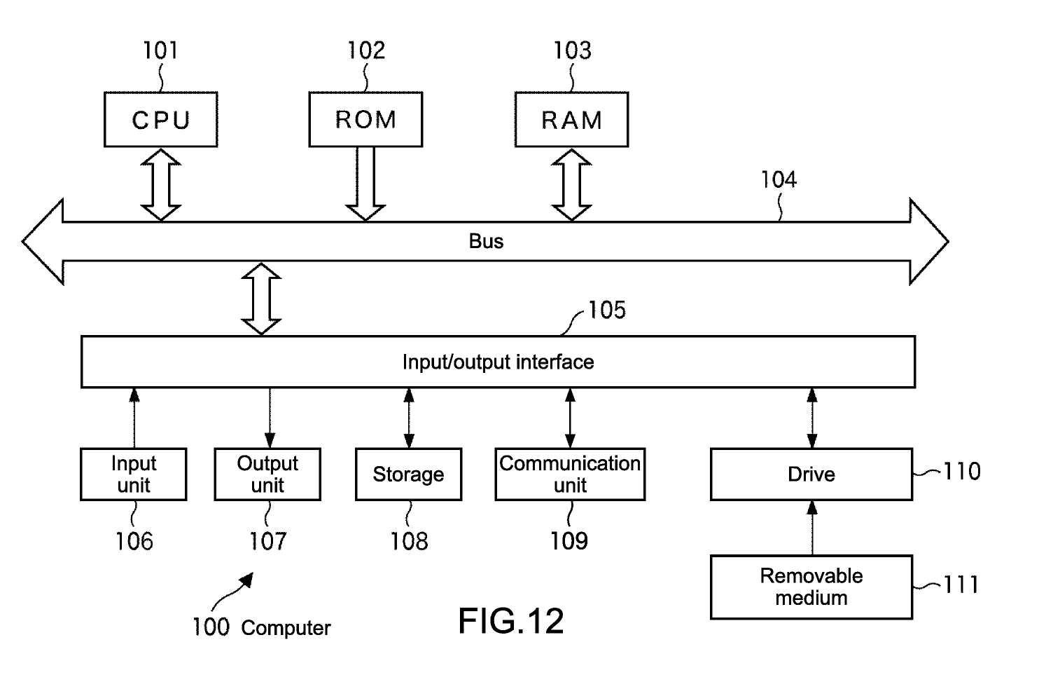

In view of this, FIG. 12 shows a configuration example of an embodiment of the computer into which the program for executing the sequence of processing steps described above is installed.

The program can be stored in advance in a storage 108 such as a built-in hard disk of a computer 100, or a ROM (Read Only Memory) 102.

Alternatively, the program may be temporarily or permanently stored (recorded) in a removable medium 111 such as a flexible disk, a CD-ROM (Compact Disc Read Only Memory), an MO (Magneto Optical) disk, a DVD (Digital Versatile Disc), a magnetic disk, or a semi-conductor memory. Such a removable medium 111 can be provided as so-called package software.

It should be noted that rather than installing the program into the computer 100 from the above-mentioned removable medium 111, the program may be installed in the storage 108 in such a manner that it is transferred in a wireless manner from a download site to the computer 100 via a satellite for digital satellite broadcasting or it is transferred in a wired manner to the computer 100 via a network such as a LAN (Local Area Network) or the Internet, and then in the computer 100, the program thus transferred is received by a communication unit 109.

The computer 100 has a built-in CPU (Central Processing Unit) 101. To the CPU 101, via a bus 104, an input/output interface 105 is connected. When the CPU 101 receives an instruction input by, for example, the user operating an input unit 106 including a keyboard, a mouse, a microphone, and the like via the input/output interface 105, the CPU 101 executes, according to this instruction, the program stored in the ROM 102. Alternatively, the CPU 101 loads, to a RAM (Random Access Memory) 103, a program stored in the storage 108, a program transferred from the satellite or the network, received by the communication unit 109, and installed into the storage 108, or a program read out from the removable medium 111 mounted on a drive 110 and installed into the storage 108, and executes those programs. With this configuration, the CPU 101 executes the processing according to the flowchart described above or the processing performed by the configuration of the block diagram described above. Then, the CPU 101 outputs the result of the processing to an output unit 107 including an LCD (Liquid Crystal Display), the speaker, and the like, or sends it from the communication unit 109, for example, via the input/output interface 105 depending on needs, and records it in the storage 108, for example.

Herein, processing steps of describing programs for causing the computer to execute various types of processing do not necessarily need to be processed in time line in the order described as the flowchart. The processing steps also include processing executed in parallel or individually (e.g., parallel processing or processing by object).

Alternatively, the program may be processed by a single computer or a plurality of computers in distributed processing. In addition, the program may be transferred to a remote computer for execution.

It should be noted that herein, the system refers to the entire apparatus including a plurality of apparatuses.

Further, embodiments of the present technology are not limited to the above-mentioned embodiment, but various modifications can be made without departing from the gist of the present technology.

The present disclosure contains subject matter related to that disclosed in Japanese Priority Patent Application JP 2011-084905 filed in the Japan Patent Office on Apr. 6, 2011, the entire content of which is hereby incorporated by reference.

What is claimed is:

1. A reception apparatus, comprising:
a reception unit configured to receive, from an information processing apparatus configured to distribute content, file data of the content transmitted in a file unit;
a buffer configured to store the received file data;
a change unit configured to change a bit-rate of the file data to be received; and
a buffer control unit configured to delete, when the bit-rate is changed from a first bit-rate to a second bit-rate higher than the first bit-rate, file data other than files at least including a file being reproduced and a file to be next reproduced, out of the file data stored in the buffer.

2. The reception apparatus according to claim 1,
wherein the buffer control unit is configured to delete, when the bit-rate is changed from the second bit-rate to the first bit-rate, file data being written in the buffer.

3. The reception apparatus according to claim 1,
wherein the file data includes a video-encoded signal and an audio-encoded signal that are multiplexed,
further comprising a demultiplexer configured to separate the file data into the video-encoded signal and the audio-encoded signal,
wherein the buffer control unit is configured to provide the demultiplexer with two or more file data items read out from the buffer.

4. The reception apparatus according to claim 1, further comprising
a measuring unit configured to measure a reception speed of the file data to be received,
wherein the change unit is configured to change, based on the measured reception speed, the bit-rate.

5. A reception method, comprising: by a reception apparatus including a buffer,
receiving, from an information processing apparatus configured to distribute content, file data of the content transmitted in a file unit;
changing a bit-rate of the file data to be received; and
deleting, when the bit-rate is changed from a first bit-rate to a second bit-rate higher than the first bit-rate, file data other than files at least including a file being reproduced and a file to be next reproduced, out of the file data stored in the buffer.

6. A program for controlling a reception apparatus including a buffer, the program causing a computer to execute processing including the steps of:
receiving, from an information processing apparatus configured to distribute content, file data of the content transmitted in a file unit;
changing a bit-rate of the file data to be received; and
deleting, when the bit-rate is changed from a first bit-rate to a second bit-rate higher than the first bit-rate, file data other than files at least including a file being reproduced and a file to be next reproduced, out of the file data stored in the buffer.
